(19) United States
(12) Patent Application Publication
(10) Pub. No.: US 2020/0290428 A1
(43) Pub. Date: Sep. 17, 2020

(54) Method And Device For Determining The Condition Of A Driver In A Closed Vehicle Interior

(71) Applicant: Elektrobit Automotive GmbH, Erlangen (DE)

(72) Inventor: Marek Strassenburg-Kleciak, Schwalbach a. Ts. (DE)

(21) Appl. No.: 16/814,540

(22) Filed: Mar. 10, 2020

(30) Foreign Application Priority Data
Mar. 15, 2019 (DE) 10 2019 203 561.2

(51) Int. Cl. B60H 1/00

(52) U.S. Cl. CPC B60H 1/00742; B60H 1/00849; B60H 1/008

(57) ABSTRACT

Method and device for determining a driver state including measuring volatile organic compounds in a passenger compartment at a first and second measuring time, measuring volatile organic compounds in the external air, determining differential values of the volatile organic compounds by comparing the measured values with a sum of the first measured value when in air intake mode and the external measured value when in air intake mode, and in the air recirculation mode.

### BACKGROUND OF INVENTION

### 1. Field of the Invention

The invention relates to a method and a device for determining a state of a driver in an enclosed vehicle passenger compartment of a vehicle, wherein the vehicle can be operated in an air recirculation mode and in an air intake mode.

### 2. Description of Related Art

To measure a state of health of a driver, parameters such as adapted prosody or particularities of the facial expressions or gestures are examined.

Components of these implicit signals also manifest in vital physiological parameters such as breathing, cardiac activity, or skin conductance.

DE102014013581A1 discloses a device for monitoring a state of health of a driver of a vehicle, comprising at least a number of sensing units, wherein information and/or a warning message can be output to the driver automatically as a function of the determined state of health and/or an intervention into a steering device and/or into a drivetrain and/or a break device can be carried out automatically, wherein the at least one first sensing unit is provided for sensing cardiac activity of the driver, at least one second sensing unit is provided for detecting signals for carrying out a breath analysis, at least one third sensing unit is provided for carrying out a sweat analysis, and at least one fourth sensing unit is provided for observing the driver, wherein the state of health is determined on the basis of the data acquired by the sensing units. By using signals acquired by sensor technology, a breath analysis, in particular with respect to the consumption of alcohol and/or hypoglycemia can be carried out, wherein a sweat analysis can preferably be carried out both chemically and also physically by correspondingly acquired signals.

CN104925002 relates to a system and a method for monitoring the surrounding air in a vehicle on the basis of sensors. The system comprises a central controller mounted in the vehicle, and a detection and sensing device. The detection and sensing device comprises a detection and sensing component for an internal vehicle and a detection and sensing component for an external vehicle, and the detection and sensing component for the internal vehicle and the detection and sensing component for the external vehicle each comprise a carbon monoxide detector, a carbon dioxide detector and a VOC detector; the carbon monoxide detector, the carbon dioxide detector and the VOC detector are each connected to the central controller mounted in the vehicle. The concentration of carbon monoxide, carbon dioxide and VOC outside the vehicle is sensed by the sensing device and compared with the concentration in the vehicle. If the concentration in the vehicle is higher than the concentration outside the vehicle, opening of the window is controlled and if the concentration outside the vehicle is higher than the concentration in the vehicle, the controller is controlled, and the window is closed, and the vehicle air-conditioning system is controlled in such a way that it opens and changes into the interior circulating mode.

### SUMMARY OF THE INVENTION

One aspect of the invention is based on a device which is improved compared to the prior art and an improved method for monitoring a state of a driver of a vehicle.

One aspect of the invention is a method for determining the state of a driver in an enclosed vehicle passenger compartment of a vehicle, wherein the vehicle can be operated in an air recirculation mode and in an air intake mode.

### The Method Comprises:

measuring a first passenger compartment measured value at a first measuring time by a passenger compartment sensor arranged in the vehicle passenger compartment and to which only passenger compartment air is applied, wherein the passenger compartment sensor is configured to measure volatile organic compounds, wherein the first passenger compartment measured value indicates the proportion of volatile organic compounds in the passenger compartment air at the first measuring time,
measuring a second passenger compartment measured value at a second measuring time, which occurs after the first measuring time, wherein the second passenger compartment measured value indicates the proportion of volatile organic compounds in the passenger compartment air at the second measuring time,
measuring a first external measured value by an external sensor arranged on the vehicle and to which only external air is applied, wherein the external sensor is configured to measure volatile organic compounds, wherein the first external measured value indicates the proportion of volatile organic compounds in the external air,
determining a first differential value of the volatile organic compounds present in the breathed-out air by comparing the second passenger compartment measured value with the sum of the first passenger compartment measured value and the first external measured value when the vehicle is operated in the air intake mode, or
determining a first differential value of the volatile organic compounds present in the breathed-out air by comparing the second passenger compartment measured value with the first passenger compartment measured value when the vehicle is operated in the air recirculation mode from the first measuring time up to the second measuring time.

According to the definition of the World Health Organisation (WHO), the term volatile organic compounds, referred to below as VOCs, denotes organic substances with a boiling range from 60° to 250° C. Volatile organic compounds include e.g. compounds of the substance groups alkane/alkene, aromatic compounds, terpene, hologenated hydrocarbons, ester, aldehyde, and ketone. These can be found, for example, in motor vehicle traffic, fuels, solvents, etc. Volatile means here that these substances evaporate quickly owing to their low boiling point or high vapor pressure.

External air is the air outside the vehicle. The vehicle passenger compartment is often referred to as a passenger cell.

The breathed-out air is that air which is produced by the driver or driver and vehicle occupants by breathing in and subsequently breathing out.

The external sensor and the passenger compartment sensor are preferably embodied as gas sensors.

It has been recognized that in the course of metabolic processes in a living organism VOCs are produced at different locations and are transported away via the blood circulation and are expelled via urine, sweat, and airways. Therefore, in the case of illness, certain metabolic processes occur differently than normal, which has an effect inter alia also on the metabolites, that is to say the products of the metabolic processes. Illnesses such as digestive problems, liver metabolism, growth of bacteria, etc. can be detected as VOC peaks in the breath by analysis.

In addition, it has been recognized that volatile organic compounds (VOC) are also contained in exhaust gas emissions from motor traffic, which emissions pass into the vehicle passenger compartment through intake air in the air intake mode and become mixed with the volatile organic compounds (VOC) that arise from the breathed-out air of the driver.

It has also been recognized that outgassing of substances such as are used for vehicles also contribute to increasing VOCs in the passenger compartment air.

In the air intake mode the external sensor measures the proportion of VOCs which pass into the vehicle passenger compartment through the intake air in the air intake mode. A passenger compartment sensor to which only passenger compartment air is applied measures the proportions of VOCs in the passenger compartment air in an enclosed passenger compartment. Using the passenger compartment sensor and the external sensor, a first differential value of the volatile organic compounds present in breathed-out air is determined either by comparison of the second passenger compartment measured value with the sum of the first passenger compartment measured value and the first external measured value in the air intake mode and/or by comparison of the second passenger compartment measured value with the first passenger compartment measured value when the vehicle is operating from the first measuring time up to the second measuring time in the air recirculation mode. If the vehicle is operated in the air recirculation mode at the first measurement up to the second measurement, the proportion of VOCs fed in from the outside can be set approximately at zero.

Therefore, a non-falsified result can be obtained, since the influence of the VOCs from the external air in the air intake mode is minimized, and the VOCs already present in the passenger compartment air are not taken into account. The measurement of the volatile organic compounds in the breathed-out air of the driver in the vehicle passenger compartment permits the state of health of the driver to be determined. In addition, impediments to driving due to alcohol can be detected.

As a result, deviations from a normal state of a driver can be detected. In this way, by analysing the breathed-out air of the driver, driving under the influence of alcohol can be determined significantly more precisely than, for example, with an image analysis of the driver.

In addition, illness of the driver can be detected by using a VOC analysis.

One aspect of the invention specifies a method for the reproducible determination of the volatile organic compounds (VOCs) in the breathed-out air in an enclosed vehicle passenger compartment.

In addition, an increase in VOCs to a dangerous level in the vehicle can be detected. In this way, particularly in summer when the air-conditioning system is running with the windows are closed, dangerous poisonous ozone (O₃) can be formed by oxygen (O₂) in conjunction with VOC in conjunction with solar radiation.

The measurement of the first external measured value is preferably carried out by the external sensor at the second measuring time. As a result, a more precise differential value can be determined.

The first differential value is preferably determined by forming differences between the second passenger compartment measured value and the sum of the first passenger compartment measured value and the first external measured value in the air intake mode or by forming differences between the second passenger compartment measured value and the first passenger compartment measured value in the air recirculation mode. Therefore, the first differential value can be determined easily.

### The Method Preferably Further Comprises:

measuring a third passenger compartment measured value at a third measuring time, wherein the third measuring time occurs after the second measuring time, by the passenger compartment sensor,
measuring a fourth passenger compartment measured value at a fourth measuring time which occurs after the third measuring time, by means of the passenger compartment sensor,
measuring a second external measured value by means of the external sensor, determining a second differential value of the volatile organic compounds present in the breathed-out air by comparing the fourth passenger compartment measured value with the sum of the third passenger compartment measured value and the second external measured value when the vehicle is operated in the air intake mode or
determining a second differential value of the volatile organic compounds present in the breathed-out air by comparing the fourth passenger compartment measured value with the third measured passenger compartment measured value when the vehicle is operated in the air recirculation mode from the third measuring time up to the fourth measuring time, and
determining a deviation by comparing the first differential value with the second differential value.

The calculated differential values are preferably stored in a database. In this way, for example an increase in the deviation can be determined or abnormal atypical values of the VOCs in the breathed-out air can be discovered. The differential values are preferably calculated on different days or at different times of day. In order to ensure that it is the same driver, a sensing device for sensing, for example, the driver's face can be provided.

The method preferably further comprises:
outputting a warning signal if the deviation exceeds a predefined threshold value.

This deviation can be output, for example, on a display.

One aspect of the invention is achieved by specifying a device for carrying out the method as described above in a vehicle passenger compartment of an enclosed vehicle, wherein the device is embodied with:
a passenger compartment sensor arranged in the vehicle passenger compartment and to which only passenger compartment air is applied, for measuring at least one first passenger compartment measured value at a first measuring time and a second passenger compartment measured value at a second measuring time subsequent to the first measuring time, wherein the passenger compartment sensor is configured to measure a proportion of volatile organic compounds in the passenger compartment air, wherein the passenger compartment sensor is configured to transfer passenger compartment measured values to a computing unit,
an external sensor arranged on the vehicle and to which only external air is applied, for measuring a first external measured value, wherein the external sensor is configured to measure a proportion of volatile organic compounds in the external air, wherein the external sensor is configured to transfer external measured values to the computing unit,
wherein the computing unit is configured to determine a first differential value of the volatile organic compounds present in the breathed-out air by comparing the second passenger compartment measured value with the sum of the first passenger compartment measured value and the first external measured value when the vehicle is operated in the air intake mode, and to determine a first differential value of the volatile organic compounds present in the breathed-out air by comparing the second passenger compartment measured value with the first passenger compartment measured value when the vehicle is operated in the air recirculation mode from the first measuring time up to the second measuring time.

The advantages of the method may also be transferred to the device.

The device preferably also has an occupation device for determining the number of vehicle occupants. These may be, for example, seat sensors. However, other sensors can also be used here.

In one preferred refinement, a system for operating the vehicle in the air recirculation mode or air intake mode is provided. The device is more preferably configured to operate the system in the air recirculation mode or in the air intake mode as a function of the first differential value and of the number of vehicle occupants. The system is preferably an air-conditioning system with a blower. Therefore, a rapid increase in VOCs in the passenger compartment air can be avoided. Therefore, in particular if multiple vehicle occupants are sitting in the vehicle it is possible to avoid an accumulation of VOC in the passenger compartment air. To check whether multiple vehicle occupants are sitting in the vehicle, it is possible, for example, to use an occupation device, for example in the form of seat sensors.

A feed line for feeding external air into the vehicle passenger compartment is preferably provided. Furthermore, the external sensor is preferably arranged in the feed line. As result it is possible to precisely determine the quantities of VOCs flowing into the vehicle passenger compartment with the intake air.

In a further preferred refinement, a sensing device for determining first biometric driver data of the driver and an evaluation unit are provided, wherein the evaluation unit is configured to calculate a health value of the driver taking into account at least the one first differential value and the biometric driver data. Therefore, all the available data can be used to determine a precise state of health.

In one preferred refinement, a memory unit is provided for storing a plurality of differential values as a function of the biometric data of the driver, wherein the evaluation unit is configured to calculate the state of health of the driver taking into account the differential values and the biometric driver data. As a result, a change in the state of health of the driver can be logged very precisely. The differential values are preferably recorded over several weeks. Therefore, when there is a deviation this long-term study can supply first indications of illness of the driver.

The device is preferably designed to store the plurality of differential values as a function of an air intake mode or an air recirculation mode. Therefore, for example, it is possible to detect hazardous irritants resulting from exhalations in the vehicle which irritate the driver in the air recirculation mode or particular irritations of the driver caused by the inflowing air in the air intake mode.

A location-determining unit is preferably provided for precisely determining the position of the vehicle, wherein the device is configured to evaluate the first differential value or the plurality of differential values as a function of the position of the vehicle. The location-determining unit may be, for example, a navigation system. Therefore, any worsening of the breathed-out air of the driver can be related to the position of the vehicle. In particular this is advantageous in an air intake mode. In this way, the VOC values in the breathed-out air can, for example, become worse when there is a high traffic volume and therefore when pollutants enter through the intake air. Also, allergies, for example as a result of the pollen count and therefore irritation of the state of the driver can be detected.

### BRIEF DESCRIPTION OF THE DRAWINGS

Further features, properties and advantages of the present invention are provided by the description that follows with reference to the accompanying figures. Schematically,

FIG. 1 is a vehicle with a device according to one aspect of the invention;

FIG. 2 is a flowchart of the method;

FIG. 3 is flowchart of the method; and

FIG. 4 shows, by way of example, the quantity of VOCs present in the breathed-out air.

### DETAILED DESCRIPTION OF THE PRESENTLY PREFERRED EMBODIMENTS

Although the invention has been described and illustrated in more detail through the preferred exemplary embodiments, the invention is not limited by the disclosed examples. Variations thereof can be derived by a person skilled in the art without departing from the scope of protection of the invention as defined by the patent claims which follow.

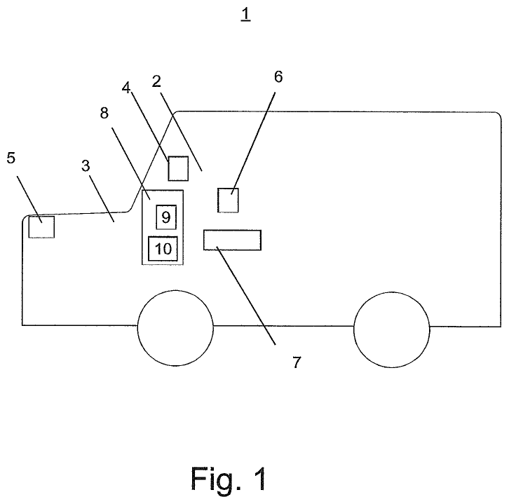

FIG. 1 shows a vehicle 1 with a device 2 according to one aspect of the invention.

The vehicle 1 has a vehicle passenger compartment 3. In addition, the vehicle 1 has a system, in particular an air-conditioning system 4 with a feed line for feeding in intake air and for recirculating the air located in the vehicle passenger compartment 3. The air-conditioning system 4 preferably has a blower, wherein the air-conditioning system 4 is able to draw intake air from outside the vehicle passenger compartment 3 and recirculation air from the vehicle passenger compartment 3 and feed it to the vehicle passenger compartment 3 by the blower. The air recirculation mode and/or air intake mode are/is controlled using the air-conditioning system 4 here. The air-conditioning system 4 can be controlled in an automated or manual fashion.

The device 2 has an external sensor 5 to which only external air is applied, in order to measure external measured values. The external measured values indicate the proportion of volatile organic compounds (VOC) in the external air. The external sensor 5 can be arranged here in or on a feed line (not shown) provided for feeding in the intake air, or on the vehicle 1. In this way it is possible to determine precisely which additional proportional quantities of VOCs are present in the intake air and which are then additionally fed to the vehicle passenger compartment 3.

The external sensor 5 is preferably embodied as a gas sensor that can measure not only VOCs but also other pollutants, for example fine dust, moisture, oxygen content, etc.

In addition, a passenger compartment sensor 6 is made available, to which only passenger compartment air is applied. The passenger compartment sensor 6 can determine the proportional quantities of VOCs present in the passenger compartment air. The passenger compartment sensor 6 is advantageously also embodied as a gas sensor.

In addition, a computing unit 8 is provided. The external sensor 5 is configured here to transfer the external measured values to the computing unit 8 and the passenger compartment sensor 6 is configured to transfer the passenger compartment measured values to the computing unit 8.

In addition, an occupation device for determining the number of vehicle occupants is provided. These may be, for example, seat sensors 7 that indicate occupation of the respective seat.

The device 2 preferably also has a sensing device (not shown) for sensing biometric data of the driver. These can be, for example, sensors on the steering wheel for sensing the heartbeat/pulse, gaze-sensing devices for sensing the movement of pupils, etc. Other sensors for sensing the biometric data of the driver can also be provided

The device 2 is preferably configured as a driver assistance system or integrated into a driver assistance system.

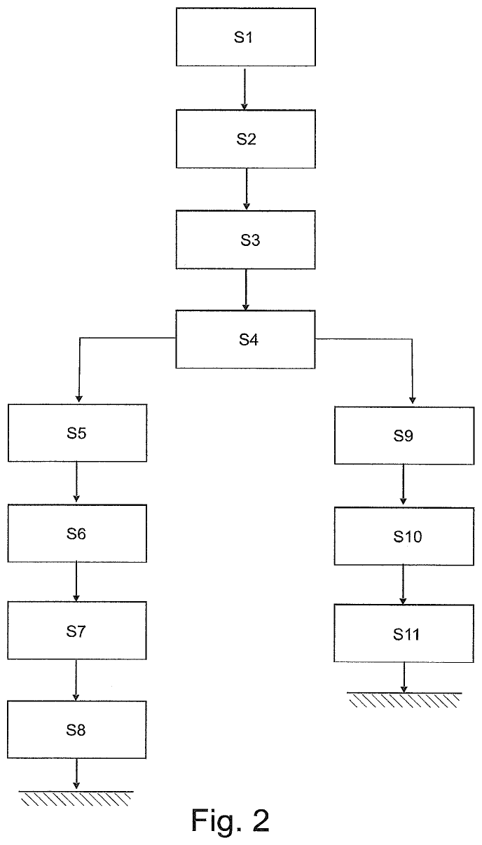

FIG. 2 shows a method according to the invention in a first refinement.

In a first step S1, a vehicle 1 (FIG. 1) is made available with a device 2 according to the invention (FIG. 1) operated in the air intake mode. In addition, the number of vehicle occupants is determined by the seat sensors 7 (FIG. 1). Preferably only the driver is identified in the following method.

Subsequently, in a second step S2 a first passenger compartment measured value is measured by the passenger compartment sensor 6 (FIG. 1) at a first measuring time. The passenger compartment sensor 6 indicates the proportion of volatile organic compounds in the passenger compartment air at the first measuring time. In this context, the first measuring time is selected in all embodiments in such a way that a first saturation point of the VOCs is present in the vehicle passenger compartment 3 (FIG. 1). The measurement is carried out with the window closed.

In a third step S3, a second passenger compartment measured value is measured at a second measuring time that occurs after the first measuring time. The passenger compartment measured value indicates the proportion of volatile organic compounds in the passenger compartment air at the second measuring time.

In addition, in the third step S3, a first external measured value is measured by the external sensor 5 (FIG. 1) at the second measuring time. The external measured value indicates the proportion of volatile organic compounds in the external air. The first external measured value and the first and second passenger compartment measured values are transferred to the computing unit 8 (FIG. 1).

In a fourth step S4, a first differential value is formed. The differential value is formed by the difference between the second passenger compartment measured value and the sum of the first external measured value and the first passenger compartment measured value:
First differential value=the second passenger compartment measured value−(first external measured value+first passenger compartment measured value).

In a fifth optional step S5, a third passenger compartment measured value is measured at a third measuring time that occurs after the second measuring time.

In a sixth optional step S6, a fourth passenger compartment measured value is measured at a fourth measuring time that occurs after the third measuring time.

In addition, in the step S6, a second external measured value is measured by the external sensor 5 (FIG. 1) at the fourth measuring time. Said external measured value indicates the proportion of volatile organic compounds in the external air. The second external measured value and the third and fourth passenger compartment measured values are transferred to the computing unit 8.

In a seventh optional step S7, a second differential value is formed. Said differential value is formed by the difference between the fourth passenger compartment measured value and the sum of the second external measured value and the third passenger compartment measured value:
Second differential value=fourth passenger compartment measured value−(second external measured value+third passenger compartment measured value).

In an eighth optional step S8, a deviation is determined by comparing the second differential value with the first differential value.

As an additional alternative, in the step S8, further biometric driver parameters of the driver can be determined and the deviation can be determined by taking into account the second differential value and the first differential value as well as the sensed biometric driver parameters.

If the deviation is greater than a predefined threshold value, a warning signal is generated. This can be, for example, an indication on a display.

It can therefore be detected, for example, that metabolic processes of the driver are possibly occurring differently than normal or are disrupted, or other illnesses are present, or a high alcohol level is present. In this way, the state of health of the driver can be determined. It is therefore possible to detect the effects of alcohol on the driver and along with this possible danger to the road traffic.

The method can be repeated until the journey is ended.

As an additional option, a memory unit 9 (FIG. 1) can be provided that stores the differential values, as well as an evaluation unit 10 (FIG. 1) by which long-term diagnostics can be produced. For this it is necessary to ensure that is the same driver in every case. This may be done, for example, by the sensing and the comparison of the biometric data.

Instead of the fifth step, a ninth step S9 can also be carried out.

In a ninth step S9, a third passenger compartment measured value is measured at the third measuring time that occurs after the second measuring time. In this context, the third measuring time occurs after the second measuring time.

In addition, in the step S9, a second external measured value is measured by the external sensor 5 (FIG. 1) at the third measuring time. The external measured value indicates the proportion of volatile organic compounds in the external air. The second external measured value and the third passenger compartment measured value are transferred to the computing unit 8.

In a tenth optional step S10, a second differential value is formed. The differential value is formed by the difference between the third passenger compartment measured value and the sum of the second external measured value and the second passenger compartment measured value:
second differential value=third passenger compartment measured value−(second external measured value+second passenger compartment measured value).

In an eleventh step S11, a deviation is determined by comparing the second differential value with the first differential value.

As an additional option or alternative, in the step S11, further biometric driver parameters of the driver can be determined and the deviation can be determined by taking into account the second differential value and the first differential value as well as the sensed biometric driver parameters.

If the deviation is greater than a predefined threshold value, a warning signal is preferably generated.

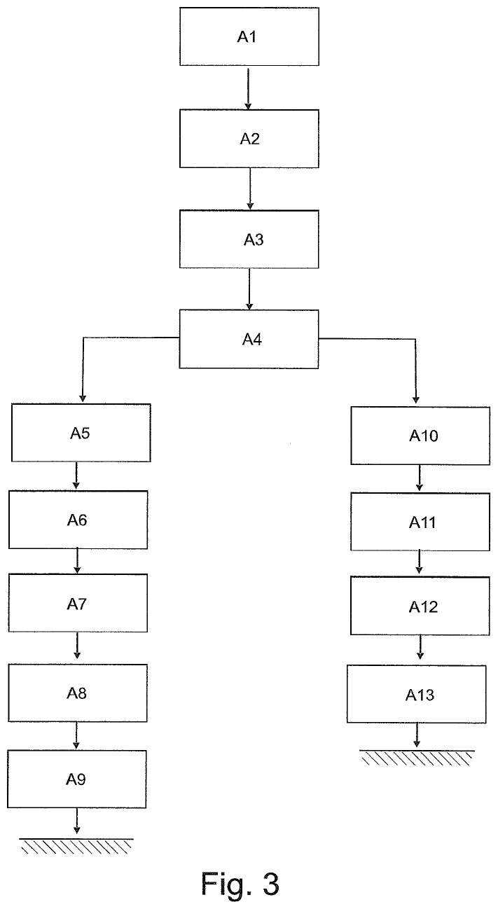

FIG. 3 shows a second refinement of the method. In this context, during the measuring process the vehicle 1 (FIG. 1) is therefore operated in the air recirculation mode at the first measuring time and the second measuring time as well as between these times.

In a first step A1, a vehicle 1 (FIG. 1) is made available with a device 2 according to one aspect of the invention (FIG. 1), wherein the vehicle 1 (FIG. 1) is operated in the air recirculation mode.

Subsequently, in a second step A2 a first passenger compartment measured value is measured by the passenger compartment sensor 6 (FIG. 1) at a first measuring time. The measurement is carried out with the window closed.

In a third step A3, a second passenger compartment measured value is measured at a second measuring time that occurs after the first measuring time. The passenger compartment measured value indicates the proportion of volatile organic compounds in the passenger compartment air at the second measuring time.

By virtue of the air recirculation mode, the proportion of fed-in VOCs can be considered to be virtually zero. The first and second passenger compartment measured values are transferred to the computing unit 8.

In a fourth step A4, a first differential value is formed. The differential value is formed by the difference between the second passenger compartment measured value and the first passenger compartment measured value:
First differential value=second passenger compartment measured value−(first passenger compartment measured value)

In a fifth step A5, a third passenger compartment measured value is measured at a third measuring time that occurs after the first measuring time. In this context, the third measuring time occurs after the second measuring time.

In a sixth step A6, a fourth passenger compartment measured value is measured at a fourth measuring time that occurs after the second measuring time. In this context, the fourth measuring time occurs after the third measuring time. The third and fourth passenger compartment measured values are transferred to the computing unit 8 (FIG. 1).

In a seventh step A7, a second differential value is formed. The differential value is formed by the difference between the fourth passenger compartment measured value and the third passenger compartment measured value:
second differential value=fourth passenger compartment measured value−(third passenger compartment measured value)

In an eighth step A8, the deviation is determined by comparing the second differential value with the first differential value.

As an additional option or alternative, in a step A9, further biometric driver parameters of the driver can be determined and the deviation can be evaluated by taking into account the second differential value and the first differential value as well as the sensed biometric driver parameters.

If the deviation is greater than a predefined threshold value, a warning signal is generated.

Instead of the fifth step, a tenth step A10 can also be carried out.

In a tenth step A10, a third passenger compartment measured value is measured at the third measuring time that occurs after the second measuring time. In this context, the third measuring time occurs after the second measuring time.

In an eleventh step A11, a second differential value is formed. The differential value is formed by the difference between the third passenger compartment measured value and the second passenger compartment measured value:
second differential value=third passenger compartment measured value−(second passenger compartment measured value).

In a twelfth step A12, a deviation is determined by comparing the second differential value with the first differential value.

As an additional option or alternative, in the step A13, further biometric driver parameters of the driver can be evaluated and the deviation can be determined by taking into account the second differential value and the first differential value as well as the sensed biometric driver parameters.

If the deviation is greater than a predefined threshold value, a warning signal is preferably generated.

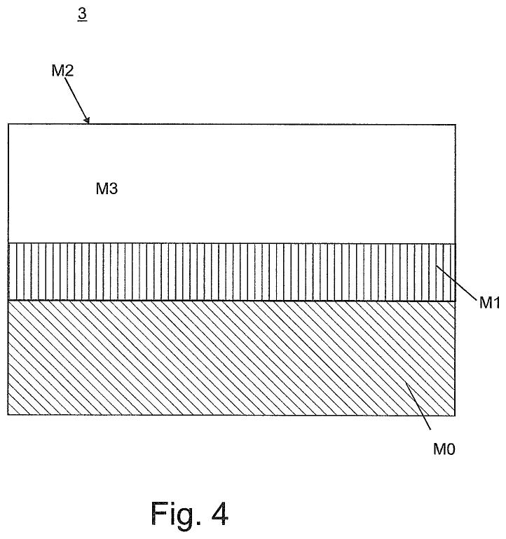

FIG. 4 shows by way of example the quantity of VOCs present in the breathed-out air. In this context, a measured quantity M2 of VOCs is present in a vehicle passenger compartment 3 at the second measuring time. This comprises a measured quantity M0 measured by the passenger compartment sensor 6 at a first measuring time. In the air intake mode, the quantity M2 also comprises the fed-in quantity M1 of VOCs present in the intake air flowing in from the outside. The quantity of VOCs produced by the driver or by the driver and the vehicle occupants during the journey or during the two measuring times is illustrated by M3.

The method and the device are designed, in particular, to produce a plurality of differential values over a relatively long time period. In particular, the device is designed to store the plurality of differential values preferably as a function of an air intake mode or an air recirculation mode.

In addition, a location-determining unit, for example a navigation system, can preferably be provided for precisely determining the position of the vehicle, wherein the device is configured to evaluate the first differential value as a function of the position of the vehicle. Therefore, long term studies relating to the driver and his or her reaction to the air recirculation mode or air intake mode can be produced and evaluated. As a result, on the one hand during the air recirculation mode and during evaluation of the associated differential values it is possible to detect hazardous exhalations in the vehicle that can irritate the driver and bring about an increased rise in VOCs in the breathed-out air as well as irritants in the intake air which also irritate the driver and can bring about an increased rise in VOCs in the breathed-out air.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method to determine a condition of a driver in an enclosed vehicle passenger compartment of a vehicle, wherein the vehicle is configured to be operated in an air recirculation mode and in an air intake mode, comprising:
measuring a first passenger compartment measured value at a first measuring time by a passenger compartment sensor arranged in the enclosed vehicle passenger compartment, wherein only passenger compartment air is applied to the passenger compartment sensor, wherein the passenger compartment sensor is configured to measure volatile organic compounds, wherein the first passenger compartment measured value indicates a proportion of volatile organic compounds in the passenger compartment air at the first measuring time;
measuring a second passenger compartment measured value at a second measuring time that occurs after the first measuring time, wherein the second passenger compartment measured value indicates the proportion of volatile organic compounds in the passenger compartment air at the second measuring time;
measuring a first external measured value indicating a proportion of volatile organic compounds in external air by an external sensor configured to measure volatile organic compounds and coupled to the vehicle, wherein only external air is applied to the external sensor; and
at least one of:
determining, when the vehicle is operated in the air intake mode, a first differential value of the volatile organic compounds present in breathed-out air by comparing the second passenger compartment measured value with a sum of the first passenger compartment measured value and the first external measured value; and
determining, when the vehicle is operated in the air recirculation mode from the first measuring time up to the second measuring time, the first differential value of the volatile organic compounds present in the breathed-out air by comparing the second passenger compartment measured value with the first passenger compartment measured value.

2. The method as claimed in claim 1, wherein the measurement of the first external measured value is carried out by the external sensor at the second measuring time.

3. The method as claimed in claim 1, wherein the first differential value is determined by one of:
forming differences between the second passenger compartment measured value with the sum of the first passenger compartment measured value and the first external measured value in the air intake mode and
forming differences between the second passenger compartment measured value and the first passenger compartment measured value in the air recirculation mode.

4. The method as claimed in claim 1, further comprising:
measuring by the passenger compartment sensor a third passenger compartment measured value at a third measuring time, wherein the third measuring time occurs after the second measuring time;
measuring by the passenger compartment sensor a fourth passenger compartment measured value at a fourth measuring time which occurs after the third measuring time;
measuring by the external sensor a second external measured value;
at least one of:
determining, when the vehicle is operated in the air intake mode, a second differential value of the volatile organic compounds present in the breathed-out air by comparing the fourth passenger compartment measured value with a sum of the third passenger compartment measured value and the second external measured value and
determining, when the vehicle is operated in the air recirculation mode from the third measuring time measuring time up to the fourth measuring time, the second differential value of the volatile organic compounds present in the breathed-out air by comparing the fourth passenger compartment measured value with the third measured passenger compartment measured value; and
determining a deviation by comparing the first differential value with the second differential value.

5. The method as claimed in claim 4, further comprising:
outputting a warning signal if the deviation exceeds a predefined threshold value.

6. A device to determine a condition of a driver in an enclosed vehicle passenger compartment of a vehicle, wherein the vehicle is configured to be operated in an air recirculation mode and in an air intake mode, comprising
a passenger compartment sensor arranged in the enclosed vehicle passenger compartment to which only passenger compartment air is applied and configured to measure at least one first passenger compartment measured value at a first measuring time and a second passenger compartment measured value at a second measuring time which is subsequent to the first measuring time, wherein the passenger compartment sensor is configured to measure a proportion of volatile organic compounds in the passenger compartment air, wherein the passenger compartment sensor is further configured to transfer passenger compartment measured values to a computing unit;
an external sensor arranged on the vehicle to which only external air is applied, and configured to measure a first external measured value, wherein the external sensor is configured to measure a proportion of volatile organic compounds in the external air, wherein the external sensor is configured to transfer external measured values to the computing unit
wherein the computing unit is configured to determine:
a first differential value of the volatile organic compounds present in breathed-out air by comparing the second passenger compartment measured value with a sum of the first passenger compartment measured value and the first external measured value when the vehicle is operated in the air intake mode, and
the first differential value of the volatile organic compounds present in the breathed-out air by comparing the second passenger compartment measured value with the first passenger compartment measured value when the vehicle is operated in the air recirculation mode from the first measuring time up to the second measuring time.

7. The device as claimed in claim 6, wherein an occupation device is provided for determining a number of vehicle occupants.

8. The device as claimed in claim 7, further comprising:
a system for operating the vehicle in the air recirculation mode or air intake mode, and configured to operate the system in the air recirculation mode or in the air intake mode as a function of the first differential value and the number of vehicle occupants.

9. The device as claimed in claim 6, further comprising:
a feed line configured to feed the external air into the enclosed vehicle passenger compartment,
wherein the external sensor is arranged in the feed line.

10. The device as claimed in claim 6, further comprising:
a sensing device for determining first biometric driver data of a driver; and
an evaluation unit configured to calculate a health value of the driver based at least in part on at least the first differential value and the biometric driver data.

11. The device as claimed in claim 10, further comprising:
a memory unit configured to store a plurality of differential values as a function of the biometric data of the driver, and
the evaluation unit is configured to calculate a state of health of the driver taking based at least in part on the differential values and the biometric driver data.

12. The device as claimed in claim 11, wherein the device is configured to store the plurality of differential values as a function of the air intake mode or the air recirculation mode.

13. The device as claimed in claim 10, further comprising:
a location-determining unit configured to determine a position of the vehicle,
wherein the device is configured to evaluate the first differential value as a function of the position of the vehicle.
